(19) United States
(12) Patent Application Publication
(10) Pub. No.: US 2009/0313581 A1
(43) Pub. Date: Dec. 17, 2009

(54) Non-Mouse Computer Input Method and Apparatus

(75) Inventor: James Thomas Martin, Burbank, CA (US)

Correspondence Address: Yahoo! Inc., c/o Kenyon & Kenyon LLP, 333 W. San Carlos Street, Suite 600, San Jose, CA, 95110, US

(73) Assignee: YAHOO! INC., Sunnyvale, CA (US)

(21) Appl. No.: 12/137,478

(22) Filed: Jun. 11, 2008

(51) Int. Cl. G06F 3/048

(52) U.S. Cl. 715/827

(57) ABSTRACT

A system and method which may allow a user to interact with a computer without having to use a mouse. If a user presses a hot key, e.g., Control+Alt+J, a user interactive control unit may look at a screen the user is currently working on, determine what on the screen may be clicked on by a mouse, assign a key to each of the clickable part, and display the name of an assigned key close to its corresponding clickable part on the screen. If the user presses a displayed key, a second screen may be presented, and the user interactive control unit may look at the second screen and determine what on the second screen is clickable by a mouse. The process may continue until the user interactive control unit determines that the user has hit his final destination and performed the operation he is interested in. Consequently, a user may use his mouse less but still be able to click on certain things. This method may save users, especially typists, considerable time.

### BACKGROUND

1. Field of the Invention

The present invention relates generally to a computer input method and apparatus, and more particularly to interacting with a computer without a mouse.

2. Description of Related Art

Nowadays, most computer operations involve use of a mouse. For example, when a user is working on a Word™ document and wants to perform a “Copy” operation, he may have to take one hand off his keyboard, find and grab a mouse, drive the mouse to the button “Edit” on his screen, click on his mouse to display the pull-down menu of “Edit,” move his mouse so that a little pointer on his screen can point at the button “Copy” on the screen, and then click on the button “Copy” to finish the operation. The use of mouse may considerably slow the user down, since the user has to move his hand off his keyboard, and to find the move his mouse.

To save time, a user may use a key-combination, e.g., “Control+C,” to avoid the use of mouse. However, relatively few operations have corresponding key-combinations, and the user has to remember the key combinations.

Therefore, it may be desirable to provide a non-mouse computer input method and apparatus which may allow a user to interact with a computer without having to use a mouse.

### BRIEF DESCRIPTION OF THE DRAWING FIGURES

Embodiments of the present invention are described herein with reference to the accompanying drawings, similar reference numbers being used to indicate functionally similar elements.

FIG. 1 illustrates a non-mouse computer input system according to one embodiment of the present invention.

FIGS. 2A, 2B, 2C and 2D illustrate screen shots of a non-mouse computer input method according to one embodiment of the present invention.

FIG. 3 illustrates a flow chart of a non-mouse computer input method according to one embodiment of the present invention.

### DETAILED DESCRIPTION

The present invention provides a method and apparatus which may allow a user to interact with a computer without having to use a mouse. If a user presses a hot key, e.g., Control+Alt+J, a user interactive control unit may look at a screen the user is currently working on, determine what on the screen may be clicked on by a mouse, assign a key to each of the clickable parts, and display the name of the assigned key close to its corresponding clickable part on the screen. If the user presses a displayed key, a second screen may be presented, and the user interactive control unit may look at the second screen and determine what on the second screen is clickable by a mouse. The process may continue until the user interactive control unit determines that the user has hit his final destination and performed the operation he is interested in. Consequently, users may use mouse less but still be able to click on certain things. This method may save users, especially typists, considerable time. The invention may be carried out in hardware, in firmware, and/or by computer-executable instructions, such as program modules. Advantages of the present invention will become apparent from the following detailed description.

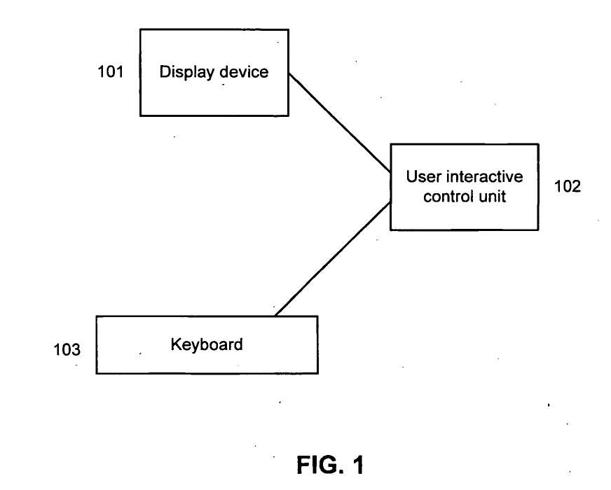

FIG. 1 illustrates a non-mouse computer input system according to one embodiment of the present invention. As shown, the system may include a display device 101, a user interactive control unit 102 and a keyboard 103.

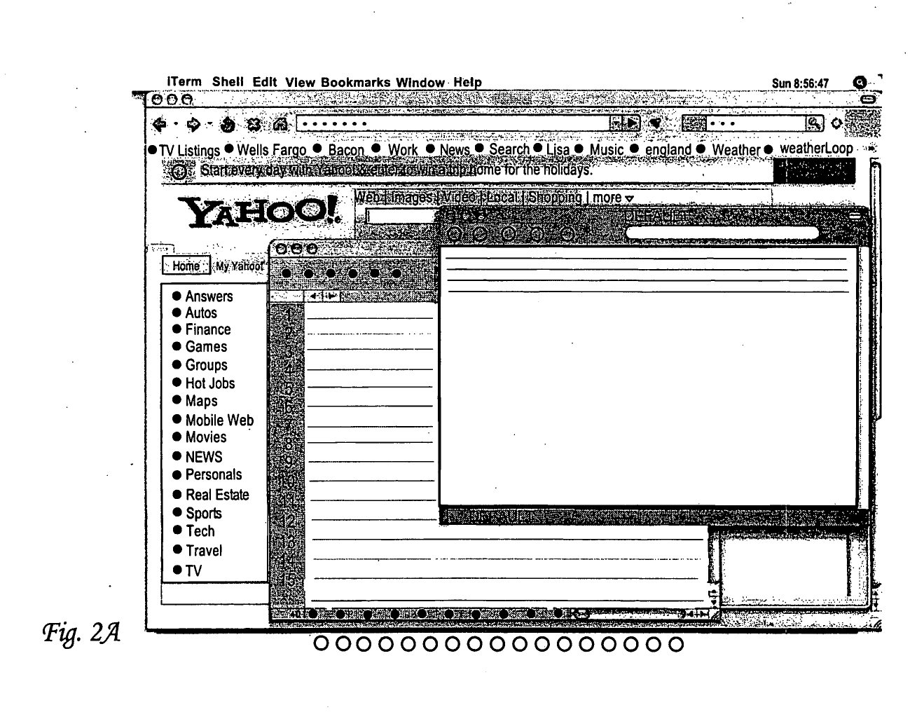

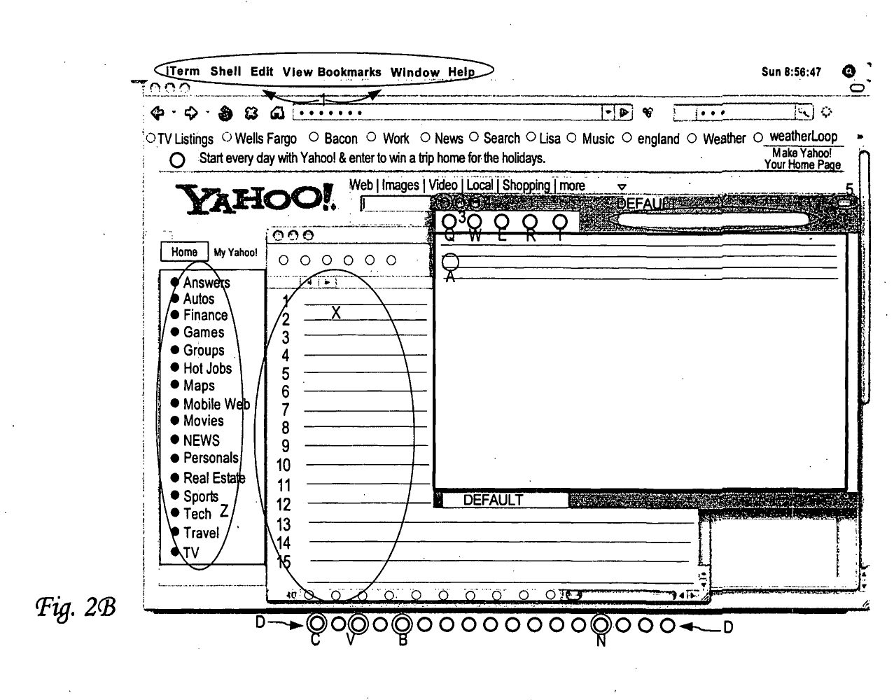

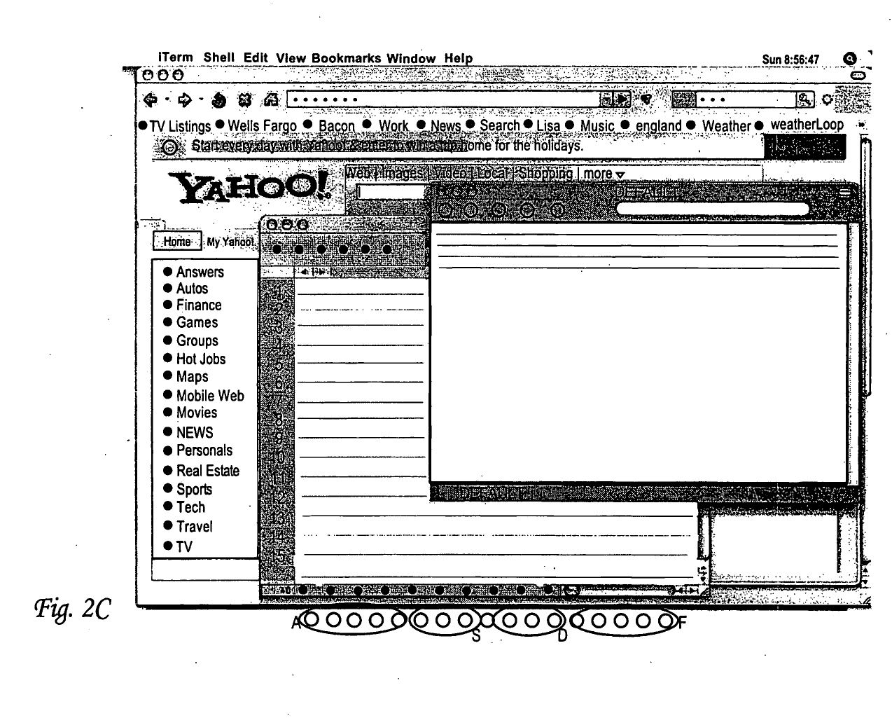

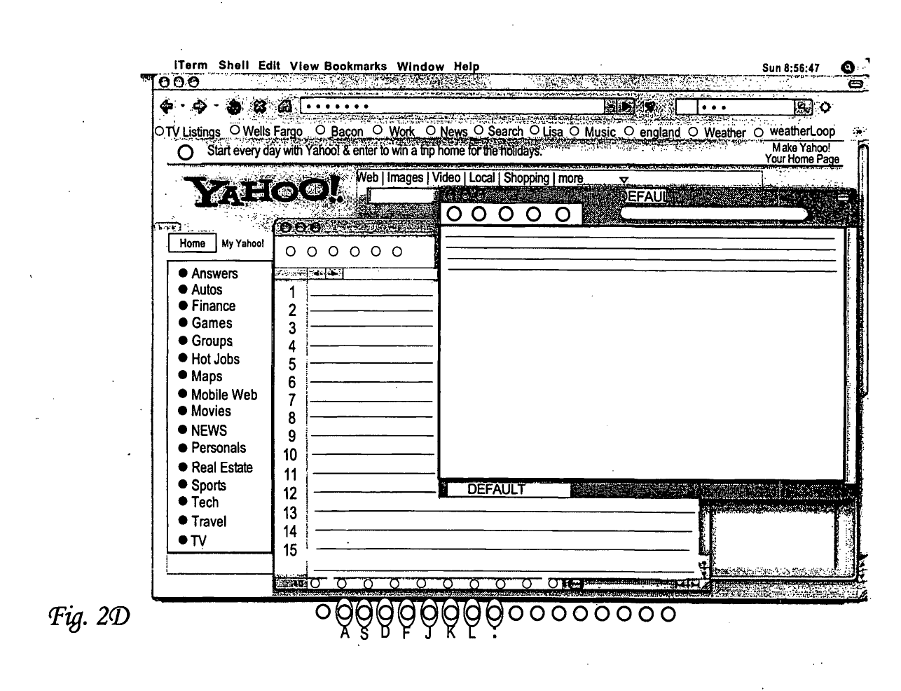

In the embodiment shown in FIG. 2A, a user may be working with a Terminal™ application on a screen displayed on the display device 101. In addition to the Terminal™ application, two other windows are displayed on the current screen: a text document under the Terminal™ application, and a Yahoo! webpage under the text document. If the user presses a hot key, e.g., Ctrl+Alt+J, on the keyboard 103, the user interactive control unit 102 may look at the current screen, determine what may be clicked on by a mouse, assign a key to each of the clickable parts, and display the name of the assigned key in a second screen, as shown in FIG. 2B. In one embodiment, a User Interface Element Inspector™ may be used to look at the current screen to determine what may be clickable.

It should be understood that the hot key may be a combination of other keys, or may be one key.

Since the Terminal™ application is the topmost application, a key may be assigned to each clickable part on the Terminal™ application, so that the user may continue to work with the Terminal™ application if he wants. For example, in FIG. 2B, keys Q, W, E, R and T may be assigned to buttons in the toolbar of the Terminal™ application. If the user wants to use any button in the toolbar, he may press a corresponding key on his keyboard. The key Y may be assigned to a Default box of the Terminal™ application. After pressing the key Y on his keyboard, the user may start to input in the Default box. If the user is unhappy with search results from the Default box, he may press “A” on his keyboard to return to the main window of the Terminal™ application, and continue his manual input.

Key 1 may be assigned to enable selection of one of the options for the program currently being displayed in the topmost window. Keys 2, 3, 4 and 5 may be assigned to buttons on the top of the Terminal™ application. For example, the key 2 may be assigned to a button for closing the Terminal™ application, the key 3 may be assigned to a button for minimizing the Terminal™ application window, and the key 4 may be assigned to a button for maximizing the Terminal™ application window. Key 5 may be assigned, as in FIG. 2B, to allow toggling of a toolbar in the window being displayed. To perform each of the operations, the user may press a corresponding key on his keyboard.

The key Z may be assigned to the webpage. If the user wants to go to the webpage from the Terminal™ application, he may simply press Z on his keyboard to make the webpage the topmost displayed program. Similarly, the key X may be assigned to the text document. If the user wants to switch to the text document, he may press X on his keyboard to make the text document window active.

A key also may be assigned to an application button displayed at the bottom of the screen. For example, the key C may be assigned to the button for Dashboard™, the key V may be assigned to the button for Safari™, the key B may be assigned to the button for iDVD™, and the key N may be assigned to the button for Painting™. As will be discussed below, the key D may be used to break the buttons down to several groups.

In one embodiment, as noted earlier, the key 1 may be assigned to menu buttons displayed on the top of the screen, as a group, and including iTerm™, Shell, Edit, View, Bookmarks, Window, and Help. If the user is interested in any operation listed in the menus, e.g., Copy, he may press 1 on his keyboard. In a second screen, while keeping other things on the screen unchanged, the user interactive control unit 102 may assign a key to each of the menu button, for example, 1 for iTerm, 6 for Shell, 7 for Edit, 8 for View, 9 for Bookmarks, 0 for Window, and 10 for Help. The user interactive control unit 102 may only use keys that have not been assigned on the current screen. If the user is interested in the operation Copy, he may press 7 on his keyboard, since the operation Copy is in the pull-down menu of Edit. As a result, the pull-down menu may be displayed below the menu button Edit in a third screen.

The user interactive control unit 102 may determine that the user is interested in operations in the pull-down menu under the menu button Edit, may remove names of keys assigned to other menu buttons (e.g., iTerm™, Shell, Edit, View, Bookmarks, Window, and Help) to keep the screen clean and make more keys available to be assigned. The user interactive control unit 102 may assign a key to each item in the pull-down menu below the menu button Edit. In one embodiment, the key 8 may be assigned to the operation Copy, and the user may press 8 on his keyboard to perform the operation. If there still are lower level operations, the procedure may repeat until the operation the user is interested in is hit.

The user interactive control unit 102 may be able to determine whether a button is a menu button or an operation button. For example, when the user presses 7 for Edit, the user interactive control unit 102 may determine that Edit is only a menu button, and is not the user's final destination, since itself does not interact with any application. Accordingly, the user interactive control unit 102 may look at the pull-down menu to figure out what could be clicked on, and assign a key to the clickable part. The user may then hit a key on the keyboard for the operation he is interested in. Each time the user presses a key, the user interactive control unit 102 may make a decision about whether the user is done or he is trying to do something else.

Thus, the system shown in FIG. 1 may simulate the user taking his hand off his keyboard, moving the mouse up to the menu button Edit, clicking on the menu button Edit, dropping down the pull-down menu under the menu button Edit, moving the mouse to the Copy button, and clicking on the Copy button. Thus, without having to move his hand off the keyboard, the user may perform the Copy operation by pressing the hot key Ctrl+Alt+J, and then 1, 7 and 8 assigned by the user interactive control unit 102, thus saving considerable operation time.

In one embodiment, a color may be used to indicate that several names of keys displayed on the screen by the user interactive control unit 102 belong to one group of operations. For example, names of keys Q, W, E, R, T, Y and A, which are all assigned to clickable parts in the Terminal™ application, may be in purple; names of keys 2, 3, 4, and 5 may all be in yellow; and names of keys C, V, B and N may be in green. In one embodiment, a same color may be used for displayed keys for one program. In one embodiment, similar colors may be used for displayed keys for one program, e.g., blue for an active program, dark blue for the close window button, and light blue for the minimize button, while other programs would be any color but blue.

In one embodiment, font styles may be used to indicate that several names of keys belong to one group of operation.

To make the assigned keys on the screen more conspicuous, in one embodiment, the user interactive control unit 102 may divide buttons into several groups, and assign one key to each group on a first screen. If the user presses a key for one group, the user interactive control unit 102 may then assign a key to each button in the group on a second screen. For example, in the embodiment shown in FIG. 2B, more than 20 application buttons are shown at the bottom of the screen. If a key is assigned to each of the application buttons, the screen may become overly crowded, and it may become difficult for the user to decide which key is assigned to which button. Thus, keys are assigned to only a few applications, which are either the most frequently used buttons or buttons related to the active window. If the user is interested in an application button but no key was assigned to it at the current screen, the user may press D on his keyboard first.

In response, the user interactive control unit 102 may look at all application buttons displayed at the bottom, divide them into several groups, and assign a key to each group. For example, as shown in FIG. 2C, Internet related applications (e.g., Safari™ and Explorer™) may be put into one group, and the key A may be assigned the group; work related applications (e.g., Word™ and Excel™) may be put into another group, and the key S may be assigned to the group; entertainment related applications (e.g., iTune™ and iPhoto™) may be put into yet another group and the key D may be assigned the group; and the key F may be assigned to a further group including everything left over. Thus, for example, if the user is interested in the application Explore™, which is not assigned a key yet, he may press A on his keyboard.

In response, the screen shown in FIG. 2D may be displayed. In FIG. 2D, a key may be assigned to each Internet related application. For example, keys A, S, D, F, J, K, L and : may be assigned to eight different applications, and the user may press K on his keyboard to go to the application Explore™.

In another embodiment, the user interactive control unit 102 may not determine the function of the buttons, and may break the buttons substantially evenly in several groups, so that each group may have a similar number of buttons. This may occur, for example, when the user has not grouped the application buttons as conveniently as shown in FIG. 2C, or simply may be one implementation irrespective of how the user has grouped the application buttons.

In one embodiment, the relationship between an operation and a key assigned to it is not predetermined or static. Instead, the user interactive control unit 102 may assign the keys spontaneously and dynamically, without specific functions for a key in the keyboard. In one embodiment, the assignment may be based on the position of a key in the keyboard and the layout of the screen. For example, in FIG. 2B, since menu buttons are at the top of the screen, the key 1, which is in a top line of the keyboard, is assigned to the menu buttons. Buttons in the toolbar of the Terminal™ operation are in the middle of the screen, and keys Q, W, E, R, T and Y, which are in a middle line of the keyboard, are assigned to these buttons. Similarly, application buttons are at the bottom of the screen, keys C, V, B and N, which are in a bottom line of the keyboard, are assigned to these buttons.

In another embodiment, the user interactive control unit 102 may assign keys which require the least user effort. For example, users usually put their fingers on keys A, S, D, F, J, K, L, and ;, and these keys may be assigned more frequently than other keys.

It should be understood that the user interactive control unit 102 may coexist with a mouse, and may not be activated until the hot key is pressed.

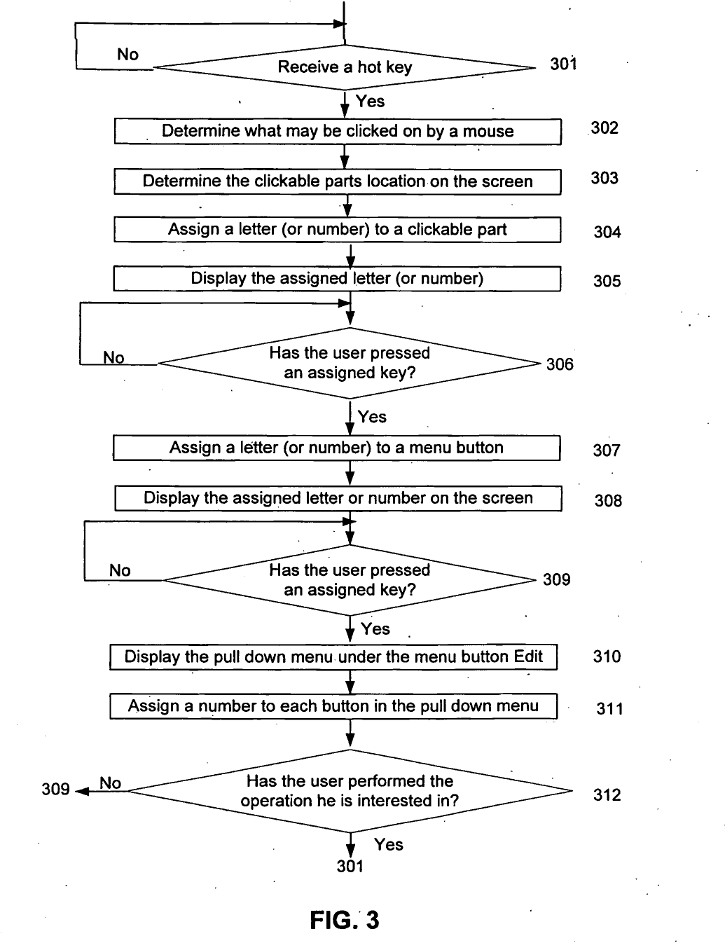

FIG. 3 illustrates a flow chart of a non-mouse computer input method according to one embodiment of the present invention. The method may be used in the system shown in FIG. 1, and a user may be working with the screen shown in FIG. 2A.

At 301, the user interactive control unit 102 may determine whether a hot key is received from the user. The hot key may be, e.g., Ctrl+Alt+J. If not, the user interactive control unit 102 may continue to wait for hot key input.

If yes, at 302, the user interactive control unit 102 may look at what is currently displayed on the screen, and determine what may be clicked on by a mouse.

At 303, the user interactive control unit 102 may determine a clickable part's location on the screen, e.g., whether it is at the top of the screen, in the middle of the screen or at the bottom of the screen.

At 304, the user interactive control unit 102 may assign a key to a clickable part. In one embodiment, the user interactive control unit 102 may map the clickable part to the keyboard, so as to assign a key in a top line of the keyboard to a clickable part at the top of the screen, assign a key in a middle line of the keyboard to a clickable part in the middle of the screen, and assign a key in a bottom line of the keyboard to a clickable part at the bottom of the screen.

At 305, the user interactive control unit 102 may display the name of the assigned key on the screen, as shown in FIG. 2B.

At 306, the user interactive control unit 102 may determine whether the user has pressed one of the assigned keys on his keyboard. If not, the user interactive control unit 102 may continue to wait.

In one embodiment, the user may want to perform a Copy operation, and presses the key 1 on his keyboard. After receiving this input, at 307, the user interactive control unit 102 may look at the group of menu buttons, and assign a key to each of the menu buttons. In one embodiment, since the menu buttons are at the top of the screen, keys 1, 6, 7, 8, 9, 0 and 10 may be assigned to buttons iTerm™, Shell, Edit, View, Bookmarks, Windows, and Help.

At 308, the names of the assigned keys may be displayed on the screen.

At 309, the user interactive control unit 102 may determine whether the user has pressed an assigned key on his keyboard. If not, the user interactive control unit 102 may continue to wait.

Since the user wants to perform a Copy operation, and the Copy operation is in the pull-down menu under the menu button Edit, the user may press the key 7, assigned to the menu button Edit at 307. After receiving this input, at 310, the user interactive control unit 102 may display the pull-down menu under the menu button Edit.

At 311, the user interactive control unit 102 may look at the pull-down menu under the button Edit, and assign a key to each of the buttons in the pull-down menu under the menu button Edit. In one embodiment, the user interactive control unit 102 may determine that the user is not interested in other menu buttons, and remove keys 1, 6, 8, 9, 0 and 10 assigned to buttons iTerm™, Shell, View, Bookmarks, Windows, and Help, so that these keys may be reused. In one embodiment, the user interactive control unit 102 may assign the key 8 to the button Copy.

The user may press the key 8 on his keyboard to perform the Copy operation. At 312, the user interactive control unit 102 may determine whether the user has performed the function he is interested in. If yes, the procedure may return to 301. Otherwise, 309-312 may be repeated for a submenu.

Thus, the user interactive control unit 102 may display what options the user may have, and all the user needs to do is to work through each menu and eventually hit the option he is interested in, without taking his hand off the keyboard.

The invention may be carried out by computer-executable instructions, such as program modules. The program modules may be delivered to a user via the Internet or media disks. The user interactive control unit 102 also may have hardware elements which interact with software and, for example, may be part of the keyboard 103.

Several features and aspects of the present invention have been illustrated and described in detail with reference to particular embodiments by way of example only, and not by way of limitation. Those of skill in the art will appreciate that alternative implementations and various modifications to the disclosed embodiments are within the scope and contemplation of the present disclosure. Therefore, it is intended that the invention be considered as limited only by the scope of the appended claims.

What is claimed is:

1. A computer input method, comprising:
receiving a hot key from an input device;
determining at least one clickable part on a screen, wherein the at least one clickable part may perform a function when clicked on by a mouse;
assigning a key on a keyboard to the at least one clickable part irrespective of whether the clickable part has a key combination already assigned to it;
displaying the name of an assigned key on the screen; and
when the key is pressed, performing the function as if the at least one clickable part has been clicked on by a mouse.

2. The method of claim 1 wherein the clickable part is a button displayed on the screen.

3. The method of claim 2, wherein the button is a menu button.

4. The method of claim 3, further comprising: displaying a pull-down menu of a menu button when a key assigned to the menu button is pressed.

5. The method of claim 4, further comprising: assigning a key to a button in the pull-down menu of the menu button, and displaying the name of the key assigned.

6. The method of claim 3, further comprising: determining that a button is not to be pressed and removing the name of a key assigned to the button from the screen.

7. The method of claim 1, further comprising: dividing buttons displayed on the screen into at least two groups, and assigning a key to each of the groups.

8. The method of claim 7, further comprising: when the key assigned to a group is pressed, assigning a key to a button in the group.

9. The method of claim 7, further comprising: distinguishing the groups by colors of key names displayed.

10. The method of claim 7, further comprising: distinguishing the groups by font styles of key names displayed.

11. The method of claim 1, wherein a key is mapped to a clickable part on the screen according to the key's location on the keyboard and the clickable part's location on the screen.

12. A computer program product comprising a computer-readable medium having instructions which, when performed by a computer, perform a computer input method, the method comprising:
receiving a hot key from an input device;
determining at least one clickable part on a screen, wherein the clickable part may perform a function when clicked on by a mouse;
assigning a key on a keyboard to a clickable part irrespective of whether the clickable part has a key combination already assigned to it;
displaying the name of an assigned key on the screen; and
performing the function as if the clickable part is clicked on by a mouse when the key is pressed.

13. The computer program product of claim 12, wherein the clickable part is a button displayed on the screen.

14. The computer program product of claim 13, wherein the button is a menu button.

15. The computer program product of claim 14, further comprising: displaying a pull-down menu of a menu button when a key assigned to the menu button is pressed.

16. The computer program product of claim 15, further comprising: assigning a key to a button in the pull-down menu of the menu button, and displaying the name of the key assigned.

17. The computer program product of claim 14, further comprising: determining that a button is not to be pressed and removing the name of a key assigned to the button from the screen.

18. The computer program product of claim 11, further comprising: dividing buttons displayed on the screen into at least two groups, and assigning a key to each of the groups.

19. An apparatus for controlling computer input, said apparatus comprising:
a receiving unit receiving a hot key from an input device;
a determining unit determining at least one clickable part on a screen, wherein the clickable part may perform a function when being clicked on by a mouse; and
an assigning unit assigning a key on a keyboard to a clickable part irrespective of whether the clickable part has a key combination already assigned to it;
wherein the apparatus performs the function as if the clickable part is clicked on by a mouse when the key is pressed.

20. A computer input system, comprising:
a screen;
a keyboard; and
a user interactive control unit, which:
receives a hot key from an input device;
determines at least one clickable part on a screen, wherein the clickable part may perform a function when being clicked on by a mouse;
assigns a key on a keyboard to a clickable part irrespective of whether the clickable part has a key combination already assigned to it;
displays the name of an assigned key on the screen; and
performs the function as if the clickable part is clicked on by a mouse when the key is pressed.
